(19) United States
(12) Patent Application Publication
(10) Pub. No.: US 2026/0270170 A1
(43) Pub. Date: Sep. 10, 2026

(54) Network Node Point and Method for Linking Different Input Devices

(71) Applicant: Siemens Aktiengesellschaft, München (DE)

(72) Inventors: Anjelika Votintseva, Garching (DE); Maryna Zabigailo, Garching (DE)

(73) Assignee: Siemens Aktiengesellschaft, München (DE)

(21) Appl. No.: 19/489,181

(22) PCT Filed: May 16, 2024
(86) PCT No.: PCT/EP2024/063466

§ 371 Date: Dec. 1, 2025

(30) Foreign Application Priority Data
May 30, 2023 (DE) 10 2023 205 033.1

(51) Int. Cl. H04L 43/04; H04L 41/12; H04L 41/16; H04L 67/12

(52) U.S. Cl. CPC H04L 43/04; H04L 41/12; H04L 41/16; H04L 67/12

(57) ABSTRACT

Various embodiments of the teachings herein include a network node point connecting a plurality of devices in a communication network receiving and forwarding data packets. An example includes: a memory unit to buffer data packets after reception; a connection to a neural network using artificial intelligence (AI) to capture, analyze, transform, and/or process data packets or associated metadata; and a processor to using the AI to analyze data packets. The data packets are buffered, analyzed, processed and/or transformed in the network node point before being forwarded.

### CROSS-REFERENCE TO RELATED APPLICATIONS

This application is a U.S. National Stage Application of International Application No. PCT/EP2024/063466 filed May 16, 2024, which designates the United States of America, and claims priority to DE Application No. 10 2023 205 033.1 filed May 30, 2023, the contents of which are hereby incorporated by reference in their entirety.

### TECHNICAL FIELD

The present disclosure relates to computer systems. Various embodiments of the teachings herein include network node points and methods for linking different input devices, as are used, for example, when various user inputs of a virtual meeting and/or in the prototyping phase of a new product, in particular an Internet-based product, coincide at the same time and/or for solving a problem by virtue of shared design, planning, description, testing and/or by means of a shared file and/or a shared virtual workstation.

### BACKGROUND

Users of different input devices are digitally collaborating more and more often, with the result that they communicate via connections—for example in a star topology—and/or access the same memory, processor and/or output device that is at the center of the collaboration, for example a prototype of a new product and/or a concept board, on which everybody works together. For example, a plurality of users collaborate using their own input devices in each case during a virtual meeting, but there is, in particular, joint work including a shared file, for example a concept board, in such a manner that all members design and/or access the concept board together and/or at the same time.

Until now, user inputs, for example to a concept board that can be reached with a plurality of computers, a table, a file and/or a voice output, have hitherto been processed chronologically, in principle after the time of the user input. Another method for processing signals that access the same file at the same time involves manually prioritizing the computers, via which the user inputs are made, with the result that user inputs from computer A are handled and/or forwarded with a different priority to user inputs from computer M.

No matter how this is carried out, there is always a rule, by means of which, when a plurality of user inputs flow together and/or when a plurality of signals and/or data packets simultaneously coincide at a network node point, which is connected upstream of the shared computer-aided device for example, a type of priority control in terms of which input is processed and/or forwarded with which prioritization is performed for processing.

In this case, the order is either manually defined and/or takes place chronologically. The disadvantage of manual definition is the method step in which a user must think the matter through and must set the system accordingly and, in particular, the amount of time required and the rigidity because prioritizations are not automatically adapted to the current situations in a flexible and dynamic manner but rather can only be adapted laboriously and manually.

Apart from these rules, technical stumbling blocks sometimes curb the flowing together of a plurality of user inputs because, for example, there is a lack of compatibility between the individual devices. This is the case when signals that cannot be readily transferred and/or accepted are transmitted or received, because, for example, operating systems and/or connections are effected via user inputs and/or different technical possibilities, arrangements, commands, signals from the individual interconnected computers are not matched to one another. It may be the case that collaboration of a plurality of users via different computers is possible only after appropriate technical adaptation, possibly even after upgrading and/or training the systems.

In particular for MVP, “Minimum Viable Product”, testing, in which prototypes are tested and different variants are simulated in order to determine the best and most user-friendly method and/or technical solution, it is the case more and more often that the users are thwarted by technical stumbling blocks—as described above, produce unusable results and/or arrive at usable results only after many different attempts, training, updates and/or other tests. A disadvantage of previously known network node points is that it receives data and forwards said data completely and chronologically to all connected devices. When received at the same time, the result may therefore be the collision of data packets, which can lead to performance problems in the network. It may thus be useful to forward data packets containing particular meta data preferably and/or only to particular devices, which is not possible with the previously conventional, non-processing network node points.

### SUMMARY

There is therefore the need for a solution to the above-described problem of integrating various simultaneous and/or incompatible user inputs in a shared computer-aided device, in particular for a shared file, platform, tool and/or access and/or a processor shared between the users, wherein the user inputs come from different, possibly also incompatible, computer-aided devices. The teachings of the present disclosure provide apparatus and methods for integrating simultaneously occurring signals from different devices of a network, in particular at a time at which a plurality of network participants make inputs and/or access one or more shared files, platforms or tools.

For example, some embodiments of the teachings herein include a computer-implemented network node point connecting a plurality of computer-aided devices in a communicating computer network such that it receives and forwards data packets, wherein the data packets are buffered, analyzed, processed and/or possibly transformed in or via the network node point before being forwarded, wherein the network node point has a computer-aided prioritization and/or transformation module having the following components: e) at least one memory unit for buffering the data packet(s) from the connected computer-aided devices after being received, f) at least one processor which is suitable for reading out received data packets and/or their meta data, g) at least one connection to a neural network having AI for capturing/analyzing and/or for transforming and/or processing the data packet(s) before being forwarded, and h) at least one processor which is suitable for applying the results of the prioritization and/or analysis of data packets by the AI to the forwarding, transformation and/or processing of the data packets for the memory, processor and/or output device shared by the network.

In some embodiments, the processor has an interface to the IoT.

In some embodiments, the network node point has a star-shaped topology.

In some embodiments, the network node point has a chain-like topology.

In some embodiments, the network node point has a point-to-point topology.

In some embodiments, the processor has at least one interface to at least one feedback capture device of an output device.

In some embodiments, the processor has at least one output device for visualizing the prioritization performed by the AI or manually.

In some embodiments, the network node point is connected to a computer-aided output device shared in the virtual project space.

As another example, some embodiments include a computer-implemented method for the collision-free forwarding of a plurality of data packets from different computer-aided input devices, which are connected to one another via a network node point, to one or more output device(s), which is/are likewise connected to the network node point, comprising the following method steps: capturing each network participant—“participant” for short—using an identity, receiving at least one input and/or one command from one of the participants by means of the network node point, capturing and/or storing user inputs in the same project space of the network node point, processing the input and/the command by means of a processor of the network node point that has AI, assigning and storing a priority of each network participant by processing the collected information by means of AI and subsequently prioritizing each participant, reading out the inputs and/or commands from the participants and/or event lists in the feedback from the output devices, analyzing and prioritizing the inputs and/or commands by means of artificial intelligence and/or processing the user inputs by means of AI, generating results by means of the AI with regard to the prioritization of the inputs and/or commands from the respective participants and forwarding the inputs and/or commands according to the prioritization results, capturing and/or reading out the feedback and/or event lists received from the output device and relating to the successful forwarding and execution of the input and/or the command by an output device, and finally analyzing the feedback and checking the prioritization by the AI.

In some embodiments, the method includes classifying a participant in a group with respect to their role in the project and/or their location.

In some embodiments, the method includes classifying the received data packets on the basis of their meta data.

In some embodiments, the method includes visualizing the respective current prioritization.

As another example, some embodiments include a computer product having program code means which cause the processor and/or the AI of a network node point to carry out one or more of the methods described herein when the program code means are executed by the processor.

As another example, some embodiments include a computer-readable storage medium having a computer program product as described herein.

### BRIEF DESCRIPTION OF THE DRAWINGS

The teachings herein are explained in more detail below. In the drawings:

FIG. 1 shows a diagram of an example circuit incorporating teachings of the present disclosure;

FIG. 2 shows a diagram of an example network node point incorporating teachings of the present disclosure; and

FIG. 3 shows an example visualization of results from the AI to the participants.

### DETAILED DESCRIPTION

In particular, even when the devices are not compatible from the outset, the teachings of the present disclosure provide methods which do not expect the users to become familiar with and have available all technologies of all devices in the network for collaboration and/or to not force all participants to use the same technology, but rather to allow the users to still use a system that they master best and to nevertheless enable smooth collaboration and smooth interaction of the user inputs in and on the shared and/or common device and/or file.

Various embodiments of the teachings herein include a network node point connecting a plurality of computer-aided devices in a communicating computer network such that it receives, buffers, analyzes, processes and/or possibly transforms and forwards data packets in a computer-aided manner, wherein the network node point has a computer-aided prioritization and/or transformation module having the following components:
a) at least one memory unit for buffering the data packet(s) from the connected computer-aided devices after being received,
b) at least one processor which is suitable for reading out received data packets and/or their meta data,
c) at least one connection to a neural network having AI for capturing/analyzing and/or for transforming and/or processing the data packet(s) before being forwarded, and
d) at least one processor which is suitable for applying the results of the prioritization and/or analysis of data packets by the AI to the forwarding, transformation and/or processing of the data packets for the memory, processor and/or output device shared by the network.

Some embodiments include a computer-implemented method for the collision-free forwarding of a plurality of data packets from different computer-aided input devices, which are connected to one another via a network node point, to one or more output device(s), which is/are likewise connected to the network node point, comprising the following method steps:
capturing each network participant—“participant” for short—using an identity,
receiving at least one input and/or one command from one of the participants by means of the network node point
capturing and/or storing user inputs in the same project space of the network node point
processing the input and/the command by means of a processor of the network node point that has AI,
assigning and storing a priority of each network participant by processing the collected information by means of AI and subsequently prioritizing each participant,
reading out the inputs and/or commands from the participants and/or event lists in the feedback from the output devices,
analyzing and prioritizing the inputs and/or commands by means of artificial intelligence and/or processing the user inputs by means of AI
generating results by means of the AI with regard to the prioritization of the inputs and/or commands from the respective participants and
forwarding the inputs and/or commands according to the prioritization results
capturing and/or reading out the feedback and/or event lists received from the output device and relating to the successful forwarding and execution of the input and/or the command by an output device, and finally
analyzing the feedback and checking the prioritization by the AI.

In some embodiments, the method also comprises classifying the data packets on the basis of the meta data, for example data format, file format, program version, operating system and optionally automatic transformation, and/or update and/or transmission, in a group, and, as a result, improved classification in data packets better compatible a computer-aided, optionally shared device or an output device.

In some embodiments, the method also comprises classifying a participant in a group with respect to their role in the project and/or their location.

In some embodiments, the method also comprises visualizing the respective current prioritization.

A compilation of computer programs, which manages the system resources of a network such as the memory unit, hard disk(s), transmission and reception signals and/or a connection to a neural network having AI and/or a connection to the IoT, and provides them with application programs, is referred to as the “prioritization and/or transformation module” of the network node point. As a result, the prioritization and/or transformation module forms the interface between the hardware components and the application software of the network node point. The tasks of a prioritization and/or transformation module are, for example: control of communication between the devices connected to the network node, both the devices connected in a star-shaped manner and the communication with the shared computer-aided device.

The teachings herein enable digital collaboration of a plurality of participants via their personal devices without any additional effort for adapting the inputs in various formats and/or incompatible data packets. This technology also provides the participants with more possibilities for user interactions. During a prototyping phase, for example when designing an MVP, the existing interfaces can be used again, instead of developing new interfaces for the joint collaboration. The interoperability of the devices is enabled because the AI, which is concomitantly included in the network node point, automatically downloads the latest updates and/or transformation programs from the IoT, “Internet of Things”, and adjusts the data from the users to the shared device using these programs and thus guarantees compatibility.

### During the Prototyping Phase in Particular, the Development Costs

should be kept as low as possible in order to test and implement alternatives. For this reason, the participants typically stay with one device, one tool and/or one program, for example Facebook, a particular data memory, a tool for video collaboration, for example Teams, a tool for interacting with the design prototype and so on. As a result of the AI-controlled transformation in the network node point, also called “HUB”, these tools can be retained without compatibility problems. For example, users of different capability levels can also collaborate without problems because accordingly trained AI compensates for particular capabilities that one user or another lacks.

The terms “user” and “participant” differ in the present case insofar as users are independent of a project and participants are always assigned to a common project.

According to the prior art, user inputs are lost if, for example, the first or the last user input overwrites all later or earlier inputs chronologically according to the “FIFO”, First-In-First-Out, technology or according to the “First-In-Last-Out” technology.

In some embodiments, the AI integrated in the hub is used, for example, to compare, weigh up, prioritize and classify the inputs in a rating according to the user profile and/or to assign the reliability and/or hierarchy of the user to their input and to then accordingly prioritize the input. In this case, it is useful or even necessary to update the priorities again and again, which is automatically ensured by interposing the AI, for example if a project enters a new phase, if persons or machines become inactive or become less trustworthy for any reasons. The AI in the hub can replace a human administrator and can simultaneously accelerate the processes.

A hub may also set up and define priority rules—for example which communication has priority over other communication—user communication, loading, execution, interruption and/or termination of programs, management and assignment of the processor time, management of the internal memory space, management and operation of connected devices, access restrictions and/or prioritizations.

A network node point connects devices to one another with a certain topology. Topology generally describes the structure of how node points are connected to one another. There is both a physical topology, which is mentioned here, and a logical topology. Star topology is a type of network topology and is distinguished by the fact that all terminals are connected to the distributor or node point, but the terminals are not connected to one another. Further conventional topologies are, for example, a point-to-point topology and a chain topology.

A connection and/or distribution point, a redistribution point and/or an end point for data transmission, for example, is/are referred to as a “network node point”. For example, a network node point has the ability to detect, process and/or forward transmissions for other network nodes. For example, a network node point of the generic type connects a plurality of computer-aided devices in a star-shaped manner, on the one hand, and connects at least one computer-aided device shared in the network, on the other hand.

A backbone, a gateway, a host computer, a server, a switch and/or a hub, for example, is/are referred to as a “network node”.

The possibility of looking at, displaying and/or using a file, a platform or a tool is referred to as “access”.

A tool and/or an auxiliary program is/are referred to as a “tool”. In particular, a tool is a program that performs specific tasks within a larger software package. For example, an app is a tool, wherein the difference between an app and a tool can be considered to be the fact that an app is a small program that can be operated on smartphones and/or tablets with a restricted user interface, whereas a tool can be both an auxiliary program on a smartphone and/or a tablet and on a server and/or a desktop.

A “hub” is a type of multiport repeater which, although it is not used to analyze a signal from a network participant, is used to transmit a signal. In this case, the transmitted bit and/or symbol level is regenerated in each case after transmission in the hub. However, a hub does not contribute anything to avoiding a collision because all received bits/symbols are forwarded to all network participants without filtering and on an equal footing. A hub can also be used to analyze and/or record the data traffic between network participants at each connection of the hub using network sniffers.

Artificial intelligence based on a neural network is referred to as “AI” and is trained in the present case such that it forwards data packets containing specific meta data to the communicating computers in the computer network more quickly than others via the connected control processor. According to the invention, the processing by the AI can from simple prioritization of the data packets on the basis of predefined hierarchies, conversion of the data packets into system-compatible data packets, completion, correction, supplementation of the data packets

The memory module of a network hub as used herein may be, for example, a simple RAM, “Random Access Memory”, because it is necessary to store the data packets only intermediately until being forwarded to the communicating computers.

The processor may include means for creating a protocol, which can be retrieved. The data relating to the protocol of the processor can be used, for example, to train the AI.

Meta data or meta information is structured data containing information relating to features of the data in a data block.

In some embodiments, the memory module of the network hub is configured in such a manner that it stores the meta data for access by the processor and/or the connection to the AI. The AI can automatically perform a prioritization on the basis of the meta data while simultaneously receiving a plurality of data packets. The control processor implements the prioritization, as the result of the processing of the meta data by the AI, by forwarding the data packets from the memory.

In particular when a plurality of persons collaborate on a project, they often collaborate using a plurality of devices, for example in order to jointly design, create and/or test an MVP. Because the devices belonging to the different persons are provided with different tools from different providers, they are often not compatible. This means that network problems arise and/or some involved parties initially subject themselves to complicated training so that they can participate in the MVP on an equal footing.

The interposition of AI in the network hub, as proposed here, makes it possible for the training to become obsolete for the participant because the AI prepares and, if necessary, converts the data packets from the individual participants for the system. All “computer-implemented” devices are referred to here as “computer-aided”.

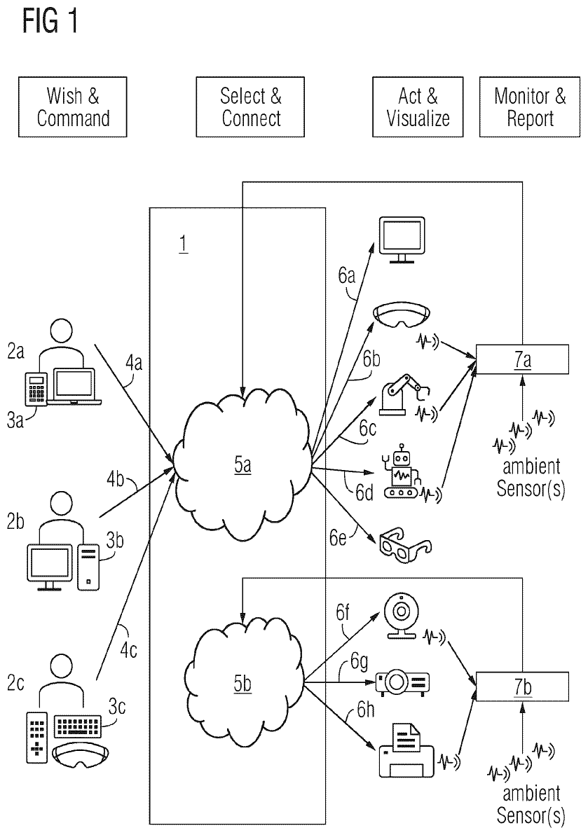

FIG. 1 shows a diagram of an example circuit incorporating teachings of the present disclosure. According to this example, the user will initially register with a selected project region “Project 1 space” for collaboration, for example using their URL that indicates the user as an ID. The user receives this ID and/or project URL by invitation from the organizer. Examples of such space IDs in the form of a URL are: MS Teams meeting, WhatsApp group, Zoom meeting or Google Meet and/or similar tools.

All users or participants in the project are then assigned IDs which code their nature as human or machine or AI and/or their location and/or their role. In addition, all participants receive a first priority; in this case, the priority of all participants may initially be the same or different or may be randomly assigned. For example, AI may receive a low priority and/or AI-controlled devices may receive a lower event priority. The initial priorities can first of all be corrected, in particular corrected by a human administrator, in which case the data from the correction can also be used again to train the AI in the hub. For example, a user in a management position receives a higher priority than a human user of a lower hierarchy.

The project participants collaborate by specifying their wishes and inputs as commands, which they input to the common project space using their preferred devices with preferred interface applications. According to the example of the present invention shown here, the interface hub forwards these commands or inputs to the actors or acting software applications which are connected in the same project space, as illustrated in FIG. 1.

FIG. 1 shows the network node point 1 in the center. To the left thereof can be seen the users 2a to 2c with their individual input devices 3a to 3c, for example a desktop, a mobile device, a smartphone, a tablet, VR, “Virtual Reality”, and/or AR, “Augmented Reality”, glasses, a microphone, a mouse, haptic input devices such as a keyboard, a touchscreen a joystick, remote control, audio input devices with or without voice recognition, and other devices sufficiently well known to a person skilled in the art, as well as any combinations of the devices mentioned.

In Addition, Automatically Generated Inputs Such As Acoustic inputs, light, temperature, magnet or sensor inputs, inputs by means of measurements and/or by means of movement/position detection sensors with a corresponding connection to an interface at the network node point can also be alternatively or additionally effected.

The input devices belonging to the participants and possibly devices having appropriate sensors communicate with the network node point 1 via suitable interfaces 4a, 4b, 4c.

Connection points between the interrelated information-processing systems or system components, such as an input device 3a to 3c and the network node point 1, via which data or control information is/are exchanged, are referred to as interfaces 4a, 4b, 4c.

Suitable interfaces 4a to 4c are, for example, all types of GUIS, “Graphical User Interfaces”, a programming interface, an API, “Application Programming Interface”, a chat application with or without an automated chat bot, a dashboard as a physical device and/or as a SW GUI, “Software Graphical User Interface”, application.

Using the above-mentioned devices 3a to 3c and the communication via the interfaces 4a to 4c, which can also comprise data from measurements and sensors, the users 2a to 2c provide inputs and/or commands which are received by the network node point 1 in a project-related manner via the corresponding URL.

According to the embodiment shown in FIG. 1, the network node point 1 is equipped with a processor 5 which has AI and optionally access to the IoT and is configured in such a manner that it receives and processes the inputs and/or commands. In this case, the processor 5 of the node point 1 can prioritize the inputs and/or commands for the respective project, can check them for reliability and/or transform them using the AI, with the result that the inputs and/or commands for a project are compatible with one another and/or with a selected output device 6a to 6h. The inputs from the users 2a to 2c which have been processed in this manner, that is to say have been prioritized, have been classified as reliable and/or are compatible, are forwarded to the output devices 6a to 6h via the network node point 1.

All input and output devices which transmit inputs and/or feedback to the processor of the network node point using a common identification are referred to as participants in a project. For example, all participants have a common URL, the project URL. All participants in a project are then in a virtual project space in which the task, the prototype, the concept board etc., on which all participants work together, and which is connected as an “output device 6a to 6h” to the network node point 1.

In order to train the AI connected to the network node point 1, the output devices 6a to 6h provide project-related feedback 7a and 7b to the processor 5 with connected AI. So-called feedback capture devices 7a, 7b, which have, for example, sensors, cameras, analysis devices, measuring instruments, microphones and/or scales, are used by the AI of the network node point 1 to receive feedback relating to the success of the output device 6a to 6h in executing the input and forwarded command, which feedback is coupled by the AI to the respective participant 2a to 2c from whom the command or the input came.

This feedback 7a and 7b contains information relating to the results of the inputs from the users 2a to 2c which are forwarded to the output devices 6a to 6h. For example, the AI is thereby informed that an input from the user 2a for an action that should be carried out by the output device 6c, a robot, is useful or not useful, with the result that the AI receives information relating to the reliability of the user 2a who can then be given a higher or lower priority or even blocked by the AI or manually by an administrator in the case of corresponding further inputs.

All inputs and all information relating to the inputs are first of all collected, stored and processed in the processor 5 of the network node point 1.

The processor 5 is connected to a prioritization and/or transformation module, for example AI and/or an interface to the IoT, which is/are integrally contained in the network node point 1.

Possible output interfaces and/or output actors that execute the input commands are: tools such as robots 6c—both for “smart home” applications and industrial robots, visual representations such as a TV, a smart TV, a monitor, a printer, VR/AR glasses, headsets, with or without HUDs, “Head-up Displays”, light signals, acoustic signals, vibration signals, and any combinations of these devices. Possibilities for visualizing the feedback 7a, 7b are, for example, screens, in a web-based manner within a web browser, and/or displays, so-called “viewers” within applications, a smart TV, VR/AR glasses, a headset or loudspeakers/sound bars for acoustic feedback, lights, LEDs, possibly mounted on dashboards, and/or combined with acoustics.

The event listener component of the processor is preferably connected to the most common interfaces available on the Internet such as SLACK®, Dropbox®, Airtable®, MQTT servers®, ThingSpeak® and/or other IoT interfaces. For example, it is also connected to social networks and/or voice assistants and uses the information available in this manner to process the inputs 4a to 4c.

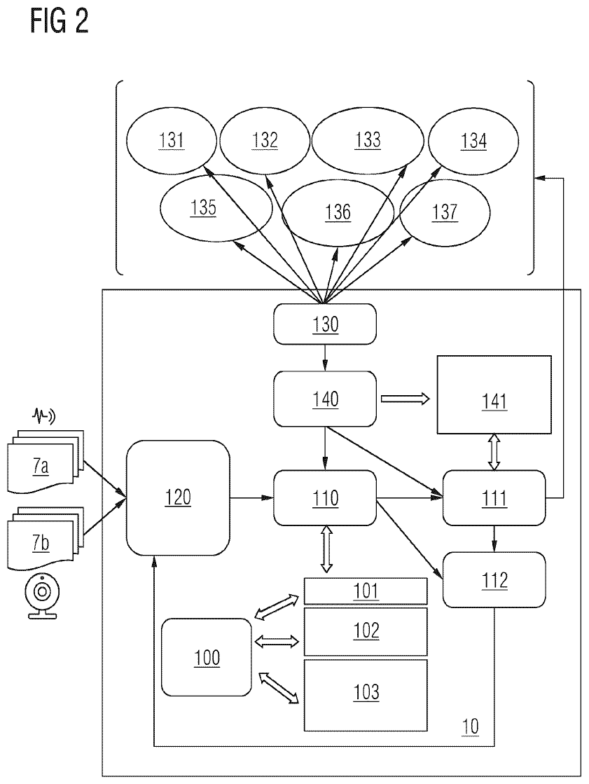

FIG. 2 shows the structure and/or the architecture of an example network node point 10 incorporating teachings of the present disclosure. The network node point 10 can be seen in the center by way of a frame and could also be the network node point 1 in FIG. 1. FIG. 2 shows a schematic circuit diagram showing how the individual elements engage with one another in an exemplary network node point 1 and how the method takes place according to one embodiment.

Within the frame of the network node point 10, the following can be seen from bottom to top: first of all process step 100, the so-called “project space definition”, where the processor assigns the input to a project on the basis of the URL of the received input. In this case, recourse is made, for example, to the list of participants 101, the list of currently connected projects 102 and the list of currently connected interfaces 103. The result in terms of which project the input should be assigned to is forwarded in process step 110 to the AI 110, the so-called “AI Decision Taker 110”. In addition, the results and information from the feedback analyzer 120, which is communicatively connected to the output devices 6a and 6f—for example with reference to FIG. 1, arrive in the AI 110 for the respective project.

Information from the interfaces to the IoT, as described above, an MQTT broker I 131 and an MQTT broker II 132, a social network I API 133, a database I 134, an IoT platform I 135, a social network II API 136 and/or a data memory 137 arrive in the AI 110 from the “event listener 130” contained in the network node point 10, as illustrated in FIG. 2, via an input command mapping 140 which transforms and classifies the information from the event listener and makes it compatible with the AI. In this case, the “Input Command Mapping” process step is coupled to the access to a “list of commands” 141 which can naturally be extended, where participants with a higher priority, for example, are further up—visible or not—and different commands are stored depending on the project.

The decisions by participants with a lower priority can still be visualized in a partially transparent manner in the user interface of the “list of commands” 141, in which case—for example—the transparency percentage corresponds to the priority. For digital twins or other visualization applications involved in a prototyping process, for example, the content of this specific user interface from the feedback analyzer with the current decisions can be integrated in these applications.

After the commands have been collected and prioritized, the network node point 1 or 10 transmits the high-priority commands to the output interfaces, for example 6a to 6h from FIG. 1, associated with this project. In this case, an output: interface may be connected to a visualization window of a web browser and/or a web cam and/or a teleconference window. A user can select which output they would like to observe from which terminal, for example the screen of a desktop computer, a laptop, a tablet, a smartphone, a smart watch, a smart TV, VR/AR glasses or a headset and/or an audio output. The possibilities of the output devices are restricted only insofar as the output device is communicatively connected to the network node point 1 or 10 and belongs to the respective project.

The AI 110 processes the data blocks containing information and/or inputs and generates the processing result as an output 111 to the corresponding devices 112 which may comprise imaging devices, for example. Devices can be deregistered and registered at any time at the network node point.

The network node point has the AI 110 which is configured once and then operates without being influenced by the participant project leader but with constant further training by means of the incoming results of the feedback analysis.

The process illustrated in FIG. 2 is dynamic and takes place in real time with respect to the work on the project because the processing by the AI 110 takes place automatically and dynamically since the AI 110 is constantly supplied with new feedback 120 which is then included in the further processing of the inputs.

A network node point 1 or 10 equipped in this manner according to one exemplary embodiment of the invention analyzes all inputs and the results of the feedback 7a and 7b that are received in the feedback analyzer 120 either via project participants and/or via machines and/or automatically via sensors. In the “Feedback Analyzer” 120 process step, a decision is then made on the trustworthiness and reliability of all participants, and the priorities of the inputs are automatically based on the current trustworthiness of the participants. For example, a participant involved more actively in the collaboration is given a higher priority than other participants with less involvement.

In the “Feedback Analyzer” 120 process step, all feedback relating to the resulting scene is collected; in this case, automatically captured sensor values as well as views and data from connected cameras with facial expression recognition—for example gesture recognition, inputs from participants via corresponding platforms and/or user interfaces are available. The AI 110 can act out all possibilities here; assessments, chronology, frequencies etc. can contribute to the result of the feedback analyzer 120.

For example, some devices may communicate in sync with the network node point 1 or 10. In this case, for example, an input forwarded by the network node point 1 or 10 is processed and “OK” or “error” feedback is returned to the feedback analyzer 120. This feedback is assigned to the device from which the input was made, with the result that the prioritization of the participant who used this device for the input can be adapted.

Some devices may possibly not react immediately to a received command with feedback. This may happen in situations in which the results depend on multiple actions by different participants or if a participant does not have the functionality to send feedback. Such situations may be captured—for example for safety reasons—by additional sensors. These sensors may also comprise, by means of corresponding apparatuses, ambient temperature, noise level etc. The AI 110 can then carry out an analysis on the basis of all information in order to learn which command sequences result in “positive” feedback and which sequences result in “negative” feedback.

Negative feedback is, for example, an “error”, “alarm” or “failed” signal automatically output by the output device, for example the robot, whereas positive feedback is expressed, for example, by “okay”, “passed”, “finished”. In this case, the feedback analyzer 120 is trained with <command_sequence, feedback> and learns to predict which combination of commands can result in “negative” or “positive” values from the sensors. At the same time, the AI 110 will also prioritize the participants giving rise to a positive signal in the feedback analyzer 120.

In some embodiments, the feedback analyzer 120 has an additional user interface, via which the results of the current prioritization are visualized and the participants are informed about the decisions and prioritizations. The users recognize this and can understand the statement of which participant is classified as unreliable by the AI on account of which commands, can compare the statement with reality and correct it if necessary. This also provides the participants with the opportunity to improve the automated decision by the AI, which can then be used as a new input to train the AI.

There are many exemplary embodiments, for example that of a makerspace for 3D printing and/or laser cutting, where the AI 120 in the network node point 1 or 10 can provide the user with valuable advice in terms of which settings provide better and worse results by checking the feedback for each individual input. A transaction of the input from a participant for a model into a 3D-printable model is assessed with ok as the feedback. This setting is given a high priority, which is also visible to the participant, by the network node point. Otherwise, the AI of the network node point 1 or 10 returns “error” as the feedback if it recognizes that it cannot print this file.

In some embodiments, the network node point 1, 10 in the process represents a checking tool which collects, assesses and analyzes all data, both the inputs from the participants and the feedback messages from the output devices.

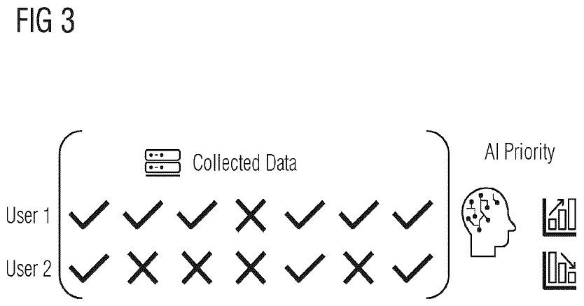

FIG. 3 shows a possible example of how the results from the AI 110 can be visualized to the participants. In this case, with a green tick, on the one hand, and a red cross, on the other hand, how often forwarding of an input 4a to 4c from a participant that is to say in one row—resulted in success in the output device 6a to 6h and how often it did not result in success according to the feedback analyzer 120.

In some embodiments, it is then within the participant's discretion to correct this result from the AI 110 using the data from the feedback analyzer 120 or to leave it.

In some embodiments, the inputs from the participants are constantly monitored by the network node point 1 or 10. The progression of the monitoring results can likewise be retrieved in the AI, with the result that, on the basis of the collected historical data relating to the participants, inputs and feedback, the network node point will assign a corresponding priority to each participant for their type of input. There is a high priority for the correct type of input, which can be seen, for example, in the “list of commands” 141 from FIG. 2. The total number of errors per period is generally reduced by interposing a network node point containing AI 1 or 10.

A packaging station is described as a further example or “use case”. The packaging station in a workshop is operated by robots which can lift, carry and transport heavy packages. Commonplace machines and people work closely together and this requires a particular safety strategy. For this purpose, a sensor, for example, is integrated in the identity document or a portable device belonging to the human participant in order to immediately recognize an incident and to automatically send an alarm signal.

Robots have integrated sensors anyway which detect their current state and send this as feedback to the network node point.

In the case of an accident in which a person collapses or a robot or its load collides with a person, a sensor sends an alarm signal. This is an example of “negative” feedback for the input, which is then sent to the robot and/or other output devices, for example those which trigger alarm signals, in the packaging station.

All feedback is continuously collected by the sensors and the network node point and is immediately forwarded as inputs, which are processed in the network node point, and simultaneously automatically used to train the AI of the network node point. The AI in the network node point learns to recognize which command from which participant is responsible for this feedback and reflects this decision—for example—in the user interface of the feedback analyzer. The users can therefore see the current decision by the AI. The users can see the decision by the AI through the visualization of the results from the AI and can compare it with reality and can accordingly correct or confirm it. This user action is then likewise made available to the AI for training in order to improve the quality of the automatic prioritization. On the basis of such training, the AI can also learn to predict whether an input sequence could result in a dangerous situation or an accident. In the best case scenario, the AI can learn to decide, independently of a human check in real time and dynamically, whether or not a corresponding input from an identified user is forwarded to an output device. The AI can likewise perform the prioritization dynamically and can revise it at any time, in which case the prioritization results are preferably visualized at the same time as the change in the “list of commands” 141.

The AI 110 or the “AI Decision Taker” 110 can also be expanded, with the result that it not only prioritizes the participants and users, but also compares the output devices, on the basis of their results, with theoretical and/or working results acquired earlier and/or dynamically monitors them via the feedback 7a, 7b. For example, if, as in the above-described example of an accident in the packaging station, the robot 6c does not react to the alarm signal, but rather continues its activity, this is assessed by the AI 110 to be an incorrect action and the robot 6c is accordingly given a low priority. On the other hand, if the robot stops all activities and informs the system about the accident, for example by sending accordingly alerting feedback to the network node point and/or in another manner, this is assessed to be a correct action and the robot 6c still has a high priority or is upgraded and receives more tasks. The robot with the worst results is completely removed from the project, for example, the connection is cut and the participant is informed of this, if necessary.

Such AI 110 which is used in an expanded form and has an expanded feedback analyzer 120 with a management function automatically helps to remove broken machines and to detect and eliminate faults and therefore supports safety in the entire system.

The automatic prioritization by the AI 110 on the basis of the behavior and success of all participants 2a to 2c is carried out automatically, dynamically in real time and possibly also transparently by means of visualization according to FIG. 3, for example. All inputs are retained even if there is a data collision in the network node point 1 or 10, in which case the most valuable decisions—according to the assessment by the AI analyzer 110 are immediately implemented and the less valuable decisions are stored and implemented with a lower priority. These further inputs are immediately presented by means of a visualization—for example according to the exemplary embodiment illustrated in FIG. 3 and the order of prioritizations can also be seen in the visualization. In order to obtain the visualization in a simple but meaningful manner, an additional icon for an overview of the decision can be hidden or displayed, for example.

The automatic connection of the various interfaces, as presented here, keeps the costs of prototyping low and increases the effectiveness of the user interaction using input devices familiar to the respective user.

Different types of input and output devices that are connected within a project via the network node point also enable the smooth collaboration of persons with different capabilities, disabilities and/or cultures because the “translation difficulties” as well as the differences in the formats of the data blocks belonging to the inputs are automatically eliminated by accordingly trained AI connected to the IoT.

Inputs and the participation of entirely different users in a design/prototyping session in a virtual project space are thus possible; not only different human participants but also human users, intelligent machines and/or intelligent algorithms may work at the same time on the same task in the same virtual project space. They can all contribute at the same time—virtually or physically—to different parts of the design/prototype. If a plurality of participants attempt to contribute to the same part with simultaneous commands or inputs, the AI 110 automatically decides which is intended to be executed. This decision is constantly improved and checked over time—on the basis of the method running via the feedback analyzer 120 and the AI 110.

Irrespective of the grammatical use of the term, persons of male, female or other sexual identity are referred to as “users”, “participants”, “human participants”, “project participants” etc.

The teachings herein make it possible for the first time for different participants and different devices within a virtual project space to collaborate without problems in the sense of “without compatibility problems”, that is to say independently of, for example, capabilities, language, operating systems of the input and/or output devices, at the same time and without losses caused by data collision via a network node point.

Irrespective of the grammatical gender of a particular term, persons of male, female or other sexual identity are also included.

What is claimed is:

1. A network node point connecting a plurality of devices in a communication network receiving and forwarding data packets, the network node point comprising:
a memory unit to buffer data packet(s) after reception;
a connection to a neural network using artificial intelligence (AI) to capture, analyze, transform, and/or process data packets or associated metadata; and
a processor to using the AI to analyze data packets;
wherein the data packets are buffered, analyzed, processed and/or transformed in the network node point before being forwarded.

2. The network node point as claimed in claim 1, wherein the processor has an interface to an Internet of Things.

3. The network node point as claimed in claim 1, wherein the network node point has a star-shaped topology.

4. The network node point as claimed in claim 1, wherein the network node point has a chain-like topology.

5. The network node point as claimed in claim 1, wherein the network node point has a point-to-point topology.

6. The network node point as claimed in claim 1, wherein the processor has an interface to a feedback capture device of an output device.

7. The network node point as claimed in claim 1, wherein the processor has an output device to visualize prioritization.

8. The network node point as claimed in claim 1, wherein the network node point is connected to an output device shared in the virtual project space.

9. A method for collision-free forwarding of a plurality of data packets from different input devices connected to one another via a network node point to an output device connected to the network node point, the method comprising:
capturing each network participant using an identity;
receiving an input and/or command from one of the participants at the network node point;
capturing and/or storing user input in a single project space of the network node point;
processing the input and/the command using a processor with access to artificial intelligence (AI);
assigning and storing a priority of each network participant by processing the collected information using the AI and subsequently prioritizing each participant;
reading out the inputs and/or commands from the participants and/or event lists in the feedback from the output devices;
analyzing and prioritizing the input and/or commands using and/or processing the user inputs using AI;
generating results using the AI with regard to the prioritization of the inputs and/or commands from the respective participants;
forwarding the input and/or commands according to the prioritization results;
capturing and/or reading out the feedback and/or event lists received from the output device and relating to the successful forwarding and execution of the input and/or the command by an output device; and
analyzing the feedback and checking the prioritization using the AI.

10. The method as claimed in claim 9, further comprising classifying a participant in a group with respect to their role in the project and/or their location.

11. The method as claimed in claim 9, further comprising classifying the received data packets on the basis of their meta data.

12. The method as claimed in claim 9, further comprising visualizing the respective current prioritization.

13-14. (canceled)
